(19) United States
(12) Patent Application Publication
(10) Pub. No.: US 2004/0038060 A1
(43) Pub. Date: Feb. 26, 2004

(54) Fine structure composite and drying method of fine structure using the same

(75) Inventors: Nobuyuki Kawakami, Kobe-shi (JP); Takashi Kobori, Kobe-shi (JP); Toshihiro Kugimiya, Kobe-shi (JP)

Correspondence Address: Reed Smith, LLP, Suite 1400, 3110 Fairview Park Drive, Falls Church, VA, 22042, US

(73) Assignee: Kabushiki Kaisha Kobe Seiko Sho

(21) Appl. No.: 10/641,080

(22) Filed: Aug. 15, 2003

(30) Foreign Application Priority Data
May 13, 2003 (JP) 2003-134359
Aug. 22, 2002 (JP) 2002-242013

(51) Int. Cl. B32B 27/00

(52) U.S. Cl. 428/520; 428/500

(57) ABSTRACT

The present invention provides a fine structure composite composed of a fine structure and a protection film formed thereon. The fine structure composite is used prior to a step of drying the fine structure in a high pressure chamber using a liquefied or a supercritical fluid, and the protection film is formed of a high viscosity material. When the fine structure such as a semiconductor substrate after development is dried using a liquefied or a supercritical fluid, the surface of the fine structure such as the substrate is prevented from being spontaneously dried, and as a result, a pattern on the surface is prevented from being collapsed.

### BACKGROUND OF THE INVENTION

1. Field of the Invention

The present invention relates to fine structure composites each composed of a structure and a protection film provided thereon, which is used when the structure (fine structure), such as a semiconductor substrate, having fine irregularities (fine pattern) on a surface thereof is dried with a liquefied or a supercritical fluid so as to prevent the fine irregularities from being collapsed by spontaneous drying under atmospheric pressure, and also relates to drying methods of the structures each using this fine structure composite.

2. Description of the Related Art

In a semiconductor manufacturing process, a method is performed in some places, in which after a pattern is formed on a substrate using a photoresist, a developing solution is replaced with and removed by a rinse solution such as ultrapure water or isopropyl alcohol (IPA) (rinse step), followed by drying using a liquefied or a supercritical fluid (such as carbon dioxide) having a low viscosity.

When a rinse solution, such as ultrapure water or a common organic solvent, is spontaneously dried, there has been a problem in that convex portions of a pattern are collapsed, for example, by a capillary force generated at the interface between a vapor phase and a liquid phase or volume increase caused by heating in drying. Accordingly, in recent years, a liquefied or a supercritical fluid having a low viscosity, in which a capillary force is not generated because the interface between a vapor phase and a liquid phase is not present and which has a superior penetrating force between fine patterns, have begun to be used for removal of a rinse solution and for drying of a substrate.

In an actual semiconductor process, generally, development, rinse, and the like are performed under atmospheric pressure, and drying using a liquefied or a supercritical fluid is performed in a high pressure chamber; hence, after a rinse step, a step of transporting a semiconductor substrate to a high pressure chamber is carried out. In the transport step, a robot arm is generally used. When a rinse solution is spontaneously dried during this transport step, since the pattern is collapsed as described above, some types of measures must be taken so that the surface of the semiconductor substrate is not brought into contact with the air.

As one of the measures described above, a method may be mentioned in which a semiconductor substrate is placed in a container such as a Petri dish with a high boiling point liquid and is transported to a high pressure chamber while totally immersed in the liquid, followed by drying of the substrate which is placed in the container. However, in this transport, since a robot arm must be controlled and operated with considerable care so that the liquid is not spilled out of the container, handling using the robot arm becomes more difficult, and in addition, the structure of the robot device becomes complicated. In addition, an excessive amount of liquid must be disadvantageously used in terms of cost.

In addition, as another method for preventing spontaneous drying, a method may be mentioned in which a semiconductor substrate is transported while a liquid is held thereon by using the surface tension of the liquid, and this method is believed to be effective for preventing spontaneous drying to some extent. However, even in this method described above, by acceleration of the robot arm at the initial movement, the liquid may be spilled out of the surface of the semiconductor substrate in some cases. The spilled liquid becomes a waste and must be removed by some means; otherwise, the transport device itself is undesirably contaminated thereby.

In addition, although the necessity of preventing drying has been disclosed in Japanese Unexamined Patent Application Publication Nos. 2000-91180 and 2000-223467, a method disclosed in Japanese Unexamined Patent Application Publication No. 2000-91180 is inefficient since steps of development, rinse, and drying are all performed in a high pressure chamber of a supercritical system. Furthermore, according to Japanese Unexamined Patent Application Publication No. 2000-223467, a method in which a substrate is placed in a high pressure chamber right after a rinse step is merely used.

### SUMMARY OF THE INVENTION

Accordingly, an object of the present invention is to provide a method for easily transporting a fine structure, such as a semiconductor substrate, even by using a robot arm when the fine structure is dried with a liquefied or a supercritical fluid after development and, in addition, for preventing a pattern on a surface of the fine structure from being collapsed, the collapse being caused by spontaneous drying of the surface of the fine structure described above in the air.

In accordance with one aspect of the present invention, a fine structure composite, which can achieve the object described above, comprises: a fine structure; and a high viscosity protection film which is composed of a single material or a mixture having a viscosity of 0.2 Pa·s or more at 25° C. and which is provided on a surface of the fine structure. The fine structure composite described above is used prior to a step of drying the fine structure in a high pressure chamber with a liquefied or a supercritical fluid.

Since the high viscosity protection film is adhered to the surface of the fine structure, spontaneous drying can be prevented. In addition, in transportation of the fine structure composite using a robot arm, the high viscosity protection film is neither peeled nor removed from the surface having fine irregularities such as a pattern. Furthermore, without performing a drying step using a liquefied or a supercritical fluid right after a step, such as development or rinse, is performed using a liquid, the fine structure composite can be stored for a long period of time.

The thickness of the protection film described above is preferably in the range of from 100 nm to 100 μm.

In particular, the protection film of the present invention preferably comprises: a fluorinated oil; a mixture of poly(vinyl alcohol) and water; or an amphipathic compound containing a hydrophilic group and a hydrophobic group. In the case described above, the amphipathic compound is preferably a compound containing a hydrophobic group having a C—F bond or a compound having an OH group or a COOH group as the hydrophilic group, and in addition, a fluorinated alcohol or a fluorinated carboxylic acid is more preferable. The fluorinated oil in the present invention indicates a fluorocarbon compound or a fluorohydrocarbon compound.

In accordance with another aspect of the present invention, a method for drying a fine structure, comprises the steps of: forming the fine structure composite described above; transporting the fine structure composite so as to place it in a high pressure chamber; removing the protection film by extraction from the surface of the fine structure using a liquefied or a supercritical fluid which flows through the high pressure chamber; and evaporating the liquefied or the supercritical fluid from the surface of the fine structure by reducing the pressure.

In addition, in accordance with still another aspect of the present invention, a fine structure can be obtained from the drying method described above.

According to the fine structure composite of the present invention, since the protection film is not evaporated at room temperature under atmospheric pressure, the fine structure such as a pattern can be protected for a long period of time. Since having a high viscosity, even when the protection film is transported at a high speed in a transport step by a robot arm or the like, for example, inconvenience will not occur at all in which the protection film drips down from the surface of the fine structure. In addition, since a very thin film so as to cover the pattern can sufficiently prevent spontaneous drying, it is not necessary to put the fine structure composite in a container such as a Petri dish. Hence, when the protection film is removed by extraction from this fine structure composite in a drying step using a liquefied or a supercritical fluid, the fine structure can be dried without any troubles such as damage done to the pattern on the fine structure. Furthermore, an efficient drying method can be performed in which, after a process including development, rinse, and formation of the protection film for preventing a surface from being dried is repeatedly performed to form a plurality of the fine structure composites, the composites thus formed are placed all together in a high pressure chamber and can then be simultaneously dried in one drying step.

### DESCRIPTION OF THE PREFERRED EMBODIMENTS

In a fine structure composite of the present invention, which comprises a fine structure and a protection film provided thereon, as the fine structure which is not provided with the protection film thereon, for example, a structure having fine irregularities formed thereon, such as a semiconductor substrate after development of a photoresist provided thereon, may be mentioned; however, in addition to the semiconductor substrate described above, a metal, plastic, ceramic, or the like, which has fine irregularities formed thereon may also be mentioned by way of example. After the protection film is provided, the fine structure can be dried while the surface irregularities thereof are protected from being collapsed.

The fine structure composite of the present invention comprises the fine structure and a high viscosity protection film provided on a surface thereof and is used for transporting the fine structure into a high pressure chamber before the fine structure is dried in the high pressure chamber using a liquefied or a supercritical fluid. Since having a high viscosity and being unlikely to evaporate, the high viscosity protection film can stably stay on the surface of the fine structure for a long period of time, and hence spontaneous drying of the fine structure can be prevented. In addition, even when the fine structure composite is transported at a high speed in a transport step by a robot arm or the like, since this protection film has a high viscosity, for example, inconvenience in which the protection film drips from the surface of the fine structure will not occur at all. Furthermore, since a very thin film so as to cover a pattern can sufficiently prevent spontaneous drying, no container such as a Petri dish is necessary, and extraction and drying of the protection film may be sufficiently performed only by a drying step using a liquefied or a supercritical fluid, thereby increasing the efficiency of the drying step.

As described above, the high viscosity protection film is not evaporated at room temperature under atmospheric pressure and can protect the pattern for a long period of time. Hence, an efficient dying method can be performed in which, after a process including development, rinse, and formation of the protection film for preventing a surface from being dried is repeatedly performed to form a plurality of the fine structures composites, the composites thus formed are placed all together in a high pressure chamber and can be simultaneously dried in one drying step.

The protection film must have a high viscosity so as not to be deformed (no dripping from the surface of the fine structure) even when the fine structure is slightly inclined and is preferably composed of a single material or a mixture having a viscosity of 0.2 Pa·s or more at 25° C. The viscosity is more preferably 0.4 Pa·s or more.

As the protection film described above, a material having a high viscosity, such as a fluorinated oil, a solution thereof, a water soluble polymer such as a poly(vinyl alcohol), or a hydrate thereof, is preferably used which will not give any damage, such as swelling, to a photoresist material. As a fluorinated oil, for example, “Krytox” from Du Pont Kabushiki Kaisha and “Novec EGC-177” from Sumitomo 3M Co., Ltd. are commercially available.

In addition, a protection film composed of an amphipathic compound containing a hydrophilic group and a hydrophobic group or a protection film containing this amphipathic compound may also be used. When an amphipathic compound is used, regardless of surface properties of the fine structure, a stable film can be formed, and in addition, the film thus formed can be stably maintained. For example, in many various fine structures to which the present invention may be applied, two types of surface conditions, that is, a hydrophilic condition and a hydrophobic condition, may be simultaneously observed in some cases. In this case, when the protection film is formed using an amphipathic compound, the hydrophilic component and the hydrophobic component of the protection film act on the hydrophilic area and hydrophobic area of the surface of the fine structure, respectively, and hence a stable protection film can be formed.

The hydrophobic group of this amphipathic compound preferably has a C—F bond. As is the case of the fluorinated oil described above, the reason for this is that damage such as swelling is not given to a resin material such as a photoresist.

In addition, the hydrophilic group of this amphipathic compound is preferably an OH group or a COOH group. Among ionic hydrophilic groups, since a cationic hydrophilic group may contain a metal such as an alkaline metal or a salt thereof in many cases, a silicon wafer, which is a typical fine structure, may be seriously contaminated thereby, and hence the cationic hydrophilic group is not preferable. Furthermore, an anionic group containing a halogen atom is not preferably used since corrosion may disadvantageously occur in some cases. Hence, as the hydrophilic group, an OH group or a COOH group (or both groups) is preferable. As a result, as the amphipathic compound, a fluorinated alcohol or a fluorinated carboxylic acid is preferable.

As the fluorinated alcohol, for example, there may be mentioned CF₃CF₂(CH₂)₆OH, F(CF₂)₃CH₂OH, F(CF₂)₄CH₂CH₂OH, F(CF₂)₄CH₂CH₂CH₂OH, F(CF₂)₄(CH₂)₆OH, F(CF₂)₃OCF(CF₃)CH₂OH, F(CF₂)₆CH₂CH₂OH, F(CF₂)₆(CH₂)₃OH, (CF₃)₂CF(CF₂)₂CH₂H(CF₂)₄CH₂OH, H(CF₂)₆CH₂OH, (CF₃)₂CHOH, or CF₃CHFCF₂CH₂OH (all of those mentioned above are commercially available from Daikin Chemicals Sales Co., Ltd.; H(CF₂CF₂)ₙCH₂OH (where n is 2 to 5, those are commercially available from Showa Denko K.K.). Among those mentioned above, in view of viscosity, H(CF₂CF₂)ₙCH₂OH (in which n is 2, 3, or 4) is preferable.

As the fluorinated carboxylic acid, for example, H(CF₂)₄COOH, F(CF₂)₃COOH, F(CF₂)₄COOH, F(CF₂)₅COOH, or F(CF₂)₆COOH may be mentioned (those mentioned above are commercially available from Daikin Chemicals Sales Co., Ltd.), and among those mentioned above, in view of viscosity, F(CF₂)₄COOH or F(CF₂)₅COOH is preferably used.

As a method for forming the protection film in order to obtain the fine structure composite of the present invention, in which the high viscosity protection film is formed on a surface of the fine structure, known coating methods may be used as long as a fine structure, such as a pattern, is not collapsed. Among various methods, a spin coating method, in which a liquid is dripped from a nozzle onto the fine structure which is being rotated, is preferable since it has been frequently used in a semiconductor substrate field. In addition, a dipping method may also be used.

In a spin coating method, and also in other coating methods, when a protection film formed from a high viscosity material itself cannot be well applied between fine irregularities, the high viscosity material is preferably diluted for application. As a diluent, a solvent is preferably used which has a vapor pressure lower than that of the high viscosity material and which is evaporated at a temperature in the range of from room temperature to approximately 150° C.

In particular, when the high viscosity material is a fluorinated oil, a fluorocarbon-based solvent is preferably used. As the fluorocarbon-based oil mentioned above, for example, there may be mentioned a hydrofluoro ether derivative, such as C₄F₉OCH₃ (such as “HFE7100” from Sumitomo 3M Co., Ltd.) or C₄F₉OC₂H₅ (such as “HFE7200” from Sumitomo 3M Co., Ltd.); or Fluorinert (registered trademark) series from Sumitomo 3M Co., Ltd. such as “FC-40”, “FC-43”, “FC-70”, “FC-72”, “FC-75”, “FC-77”, “FC-84”, “FC-87”, “FC-3283”, or “FC-5312”. Those mentioned above may be used alone or in combination.

When the high viscosity material is a water soluble polymer, water may be used as a diluent. In addition, a fluorinated alcohol and a fluorinated carboxylic acid may be able to form the protection film without using a diluent; however, for example, “HFE7100”, “HFE7200” or CF₃CHFCHFCF₂CF₃ (Vertrel XF (registered trademark) from Du Pont-Mitsui Fluorochemicals Co., Ltd.) may be used as a diluent.

When a spin coating method is used for forming the protection film, by adjusting the viscosity of the solution after dilution to 1 to 2,000 mPa·s at 25° C. and setting the rotation speed to 100 to 5,000 rpm, a protection film having a uniform thickness can be formed. In addition, in order to obtain a protection film having a predetermined viscosity, the evaporation rate of the diluent may be adjusted by controlling the humidity and temperature of the circumstance at which the protection film is formed.

When the diluent is evaporated during a step of forming the protection film, on the surface of the fine structure, a protection film composed of a high viscosity material itself or a protection film composed of a mixture containing a high viscosity material and a remaining diluent is formed. Even when the diluent is not totally removed by evaporation, the object of the present invention can be achieved when a stable protection film having a high viscosity is formed, and hence the protection film formed of the mixture described above may also be used.

Accordingly, a process for forming the protection film is complete. In this process, the thickness of the protection film is optionally adjusted in accordance with the height of the irregularities of the fine structure so as to cover the whole convex portions thereof. In consideration of the height of the pattern (convex portion) of the semiconductor substrate, the thickness is preferably at least 100 nm, and a protection film having a thickness of approximately up to 100 μm can be stably formed. When the thickness of the protection film is more than 100 μm, since the whole pattern has been already covered with a smaller thickness, the material for the protection film is unnecessarily consumed, and in addition, cracking may occur when the diluent is evaporated therefrom. Hence, the thickness is preferably set to 100 μm or less.

Before the process for forming the protection film on the surface of the fine structure, the fine structure is preferably rinsed with the diluent described above or a mixed solution of the diluent and a solvent having an affinity thereto so that an unnecessary material such as another rinse solution used after development is replaced therewith. In particular, after the rinse is performed using ultrapure water following the development, when a protection film composed of a fluorinated oil is formed on the fine structure, in order to prevent water from penetrating into the protection film, the fine structure is preferably rinsed with a mixed solution of a diluent (fluorocarbon-based solvent) and a solvent having an affinity thereto. On the other hand, when an aqueous poly(vinyl alcohol) solution is used as the protection film, water may penetrate into the protection film. As the “solvent having an affinity to a fluorocarbon-based solvent”, a fluorinated alcohol having a low viscosity is preferable, and for example, there may be mentioned 2,2,2-trifluoroethanol, 2,2,3,3-tetrafluoro-1-propyl alcohol, 1,1,1,3,3,3-hexafluoro-2-propyl alcohol (F6-IPA), and 2,2,3,3,4,4,4-heptafluoro-1-butanol.

When a film containing a fluorinated alcohol or a fluorinated carboxylic acid is used as the protection film, rinse is preferably performed using a fluorinated alcohol or a fluorinated carboxylic acid, which has a low molecular weight and a low viscosity, before the protection film is formed.

A method for obtaining a dried fine structure, of the present invention, comprises the steps of: forming the protection film on the surface of the fine structure by the process described above so as to form the fine structure composite; transporting the fine structure composite so as to place it in a high pressure chamber; then removing the protection film by extraction from the surface of the fine structure using a liquefied or a supercritical fluid; and drying the fine structure.

The transport step of transporting the fine structure composite (composed of the fine structure and the protection film provided thereon) may be manually performed or mechanically performed using a robot arm or the like. When the fine structure composite is placed in an opened high pressure chamber, the transport step is complete. As described above, since the protection film stably stays on the fine structure for a long period of time, after the protection films are formed on the surfaces of a number of the fine structures and are then stored, a plurality of the fine structure composites thus formed may be sequentially transported and placed in a large high pressure chamber in the transport step.

Next, the drying step is performed. In particular, the high pressure chamber containing the fine structure composite is sealed, a liquefied or a supercritical fluid is allowed to flow through the high pressure chamber, the protection film is removed from the surface of the fine structure by extraction, and the liquefied or the supercritical fluid is evaporated from the surface of the fine structure by reducing a pressure inside the chamber, thereby completing the drying step. When the protection film is removed by extraction, a mixed fluid of the diluent (the rinse solution described above may be used which is used before the protection film is formed) and a liquefied or a supercritical fluid is first allowed to flow through the chamber, and subsequently, a pure liquefied or supercritical fluid may be allowed to flow therethrough.

As the liquefied or the supercritical fluid which can be used for the drying of the present invention, water can be used; however, carbon dioxide is preferably used since it is placed in a supercritical state at a lower temperature under a lower pressure than those of water, is easily evaporated under atmospheric pressure, and is stable and harmless. Liquefied carbon dioxide is carbon dioxide pressurized at a pressure of 5 MPa or more, and in order to obtain supercritical carbon dioxide, the temperature and the pressure may be set to 31.2° C. or more and 7.1 MPa or more, respectively. When carbon dioxide is used, the pressure in the drying step is preferably in the range of from 5 to 30 MPa, and more preferably, in the range of from 7.1 to 20 MPa. The temperature is preferably in the range of from 31.2 to 120° C. When the temperature is less than 31.2° C., since the high viscosity material forming the protection film is unlikely to be dissolved in carbon dioxide, the removal of the protection film from the surface of the fine structure takes a long period of time, and as a result, the efficiency of the drying step is decreased. On the other hand, when the temperature is more than 120° C., the efficiency of the drying step is not improved, resulting in a waste of energy. The time necessary for the drying is optionally changed in accordance with the size of the fine structure composite or the like, and for example, approximately 5 to 50 minutes may be enough therefor.

After the high pressure treatment is complete, when the pressure inside the high pressure chamber is returned to atmospheric pressure, carbon dioxide is rapidly turned into vapor and evaporated, and hence the drying is complete while the fine pattern of the fine structure is not collapsed. Before the evacuation, the carbon dioxide in the high pressure chamber is preferably placed in a supercritical state. The reason for this is that since the pressure can be reduced only through a vapor phase, the pattern can be prevented from being collapsed. In the present invention, the fine structure which is dried by the drying method described above is also included.

### EXAMPLES

Hereinafter, the present invention will be described in detail; however, the present invention is not limited thereto, and it is to be understood that changes and variations may be made without departing from the spirit and the scope of the present invention. In addition, “part” and “%” indicates “mass part” and “mass %”, respectively, unless particularly stated otherwise.

### Example 1

Photoresist “UV2” from Shipley Company L.L.C. was applied onto a silicon wafer which was rotated at a speed of 3,000 rpm, thereby forming a resist film having a thickness of 4,000 Å. Next, after pre-baking was performed at 130° C. for 90 seconds, patterning was performed by electron beam exposure (an electron beam acceleration of 50 keV; an electron dose of 10 μC/cm²). In addition, after post-exposure baking was performed at 140° C. for 90 seconds, the wafer provided with the resist film was developed for one minute using an aqueous solution containing tetramethylammonium hydroxide (TMAH) at a concentration of 2.38% used as a developing solution. While the wafer thus developed was rotated, ultrapure water was supplied from above the wafer, thereby rinsing the developing solution out (rinse). Subsequently, before the surface of the wafer was dried, H(CF₂CF₂)ₙCH₂OH (C₄F₉OC₂H₅ from Sumitomo 3M Co.; “HFE-7200; a boiling point of 76° C.; hereinafter referred to as “HFE”) was supplied from above the surface of the wafer while it was being rotated, thereby totally removing the water on the surface.

Before the surface of the wafer was dried, a HFE solution containing a fluorinated oil (“Krytox” from Du Pont Kabushiki Kaisha) at a concentration of 10% was supplied onto the surface of the wafer while it was rotated (a speed of 500 rpm). When the wafer was continuously rotated after the supply thereof was finished, HFE having a low vapor pressure was rapidly evaporated, and as a result, a thin protection film only composed of the fluorinated oil was formed. The ambient temperature was 23° C. When the viscosity of the fluorinated oil itself (at 25° C.) was measured by a paste meter from MAICON, it was 1,800 mPa·s.

After the wafer provided with the protection film was placed in a high pressure chamber, carbon dioxide heated to 50° C. beforehand was supplied into the high pressure chamber, which was maintained at a temperature of 50° C., by applying a pressure using a pump for liquid, and in addition, the pressure in the chamber containing the carbon dioxide was set to 8.0 MPa by a pressure regulator so that the carbon dioxide was placed in a supercritical state. First, in order to increase the efficiency of extracting the fluorinated oil, a mixed fluid of carbon dioxide containing HFE at a concentration of 1% was supplied, thereby removing the fluorinated oil out of the chamber. After it was confirmed that the fluorinated oil was totally removed, the supply of the HFE was stopped, and the carbon dioxide was only continuously supplied, thereby removing the HFE. By the flow of the supercritical carbon dioxide, the HFE was totally removed, and as a result, the high pressure chamber was filled only with the supercritical carbon dioxide. Subsequently, while the high pressure chamber was maintained at a temperature of 50° C., the pressure therein was reduced to atmospheric pressure, thereby drying the wafer provided with the resist film. When the resist pattern was observed by an electronic microscope, collapse of the pattern was not observed at all.

### Comparative Example 1

Right after the rinse step performed by using ultrapure water in the example described above, drying was performed by a spin drying method. When the resist pattern was observed by an electronic microscope, the pattern was almost collapsed.

### Example 2

A rinsed wafer was obtained by the steps from the start to rinse using ultrapure water, which were similar to those in example 1. Before the surface of the wafer was dried, an aqueous solution containing poly(vinyl alcohol) (“PVA500” from Wako Pure Chemical Industries, Ltd., hereinafter referred to as “PVA500”) at a concentration of 1% was supplied onto the surface of the wafer which is being rotated (a speed of 500 rpm). When the wafer was continuously rotated at a temperature of 23° C. after the supply of PVA500 was stopped, water was evaporated, and as a result, a hydrated PVA500 film having a high viscosity was formed on the surface of the wafer. The concentration of poly(vinyl alcohol) in this hydrated PVA500 was 20%. By using a calibration curve obtained beforehand from aqueous solutions of PVA500 at various concentrations, it was found that the viscosity of this hydrated PVA500 was 570 mPa·s.

After the wafer provided with the protection film was placed in a high pressure chamber, carbon dioxide heated to 50° C. beforehand was supplied into the high pressure chamber, which was maintained at a temperature of 50° C., by applying a pressure using a pump for liquid, and in addition, the pressure in the chamber containing the carbon dioxide was set to 8 MPa by a pressure regulator so that the carbon dioxide was placed in a supercritical state. First, in order to increase the efficiency of extracting PVA500, a mixed fluid of carbon dioxide containing 0.2% of water was supplied into the high pressure chamber, thereby removing PVA500 from the chamber. After it was confirmed that PVA500was totally removed, the supply of the water was stopped, and the carbon dioxide was only continuously supplied, thereby removing water. By the flow of the supercritical carbon dioxide, the water was totally removed, and as a result, the high pressure chamber was filled only with the supercritical carbon dioxide. Subsequently, while the high pressure chamber was maintained at a temperature of 50° C., the pressure therein was reduced to atmospheric pressure, thereby drying the wafer provided with the resist film. When the resist pattern was observed by an electronic microscope, collapse of the pattern was not observed at all.

Example 3

The formation of the resist film, development thereof, and formation of the protection film were performed in the same manner as those in example 2 except that an aqueous solution containing poly(vinyl alcohol) (“PVA1000” from Wako Pure Chemical Industries, Ltd., hereinafter referred to as “PVA1000”) at a concentration of 1% was used as poly(vinyl alcohol)). As was example 2, a hydrated PVA1000 film having a high viscosity was formed on the surface of a wafer. The concentration of poly(vinyl alcohol) in this hydrated PVA1000 was 20%. By using a calibration curve obtained beforehand from aqueous solutions of PVA1000 having various concentrations, it was found that the viscosity of this hydrated PVA1000 was 1,770 mPa·s.

After the wafer provided with the protection film was placed in a high pressure chamber, carbon dioxide heated to 50° C. beforehand was supplied into the high pressure chamber, which was maintained at a temperature of 50° C., by applying a pressure using a pump for liquid, and in addition, the pressure in the chamber containing the carbon dioxide was set to 8 MPa by a pressure regulator so that the carbon dioxide was placed in a supercritical state. First, in order to increase the efficiency of extraction of PVA1000, a mixed fluid of carbon dioxide containing 0.2% of water was supplied, thereby removing PVA1000 from the chamber. After it was confirmed that PVA1000 was totally removed, the supply of the water was stopped, and the carbon dioxide was only continuously supplied, thereby removing the water. By the flow of the supercritical carbon dioxide, the water was totally removed, and as a result, the high pressure chamber was filled only with the supercritical carbon dioxide. Subsequently, while the high pressure chamber was maintained at a temperature of 50° C., the pressure therein was reduced to atmospheric pressure, thereby drying the wafer provided with the resist film. When the resist pattern was observed by an electronic microscope, collapse of the pattern was not observed at all.

Example 4

A rinsed wafer was obtained by the steps from the start to rinse using ultrapure water, which were similar to those in example 1. Subsequently, before the surface of the wafer is dried, H(CF₂CF₂)₃CH₂OH was supplied thereon when the wafer was rotated, and as a result, water on the surface was totally replaced with H(CF₂CF₂)₃CH₂OH, thereby forming a protection film composed of this fluorinated alcohol on the surface of the wafer. The ambient temperature was 23° C. By using rheometer RS1 from Haake Corporation, it was found that the viscosity of this H(CF₂CF₂)₃CH₂OH itself was 0.5 Pa·s at 25° C.

After the wafer provided with the protection film was placed in a high pressure chamber, carbon dioxide heated to 50° C. beforehand was supplied into the high pressure chamber, which was maintained at a temperature of 50° C., by applying a pressure using a pump for liquid, and in addition, the pressure in the chamber containing the carbon dioxide was set to 8.0 MPa by a pressure regulator so that the carbon dioxide was placed in a supercritical state. Carbon dioxide was then continuously supplied into the chamber, thereby totally removing the fluorinated alcohol by extraction. Subsequently, while the high pressure chamber was maintained at a temperature of 50° C., the pressure therein was reduced to atmospheric pressure, thereby drying the wafer provided with the resist film. When the resist pattern was observed by an electronic microscope, collapse of the pattern was not observed at all.

Example 5

A rinsed wafer was obtained by the steps from the start to rinse using ultrapure water, which were similar to those in example 1. Subsequently, before the surface of the wafer is dried, H(CF₂)₄COOH was supplied thereon when the wafer was rotated, and as a result, water on the surface was totally replaced with H(CF₂)₄COOH, thereby forming a protection film composed of this fluorinated carboxylic acid on the surface of the wafer. The ambient temperature was 23° C. By using rheometer RS1 from Haake Corporation, it was found that the viscosity of this H(CF₂)₄COOH itself was 0.8 Pa·s at 25° C.

After the wafer provided with the protection film was placed in a high pressure chamber, carbon dioxide heated to 50° C. beforehand was supplied into the high pressure chamber, which was maintained at a temperature of 50° C., by applying a pressure using a pump for liquid, and in addition, the pressure in the chamber containing the carbon dioxide was set to 8.0 MPa by a pressure regulator so that the carbon dioxide was placed in a supercritical state. Carbon dioxide was then continuously supplied into the chamber, thereby totally removing the fluorinated carboxylic acid by extraction. Subsequently, while the high pressure chamber was maintained at a temperature of 50° C., the pressure therein was reduced to atmospheric pressure, thereby drying the wafer provided with the resist film. When the resist pattern was observed by an electronic microscope, collapse of the pattern was not observed at all.

What is claimed is:

1. A fine structure composite comprising:
a fine structure; and
a protection film which includes a single material or a mixture having a viscosity of 0.2 Pa·s or more at 25° C. and which is provided on a surface of the fine structure,
wherein the fine structure composite is used prior to a step of drying the fine structure in a high pressure chamber using a liquefied or a supercritical fluid.

2. The fine structure composite according to claim 1, wherein the protection film has a thickness in the range of from 100 nm to 100 μm.

3. The fine structure composite according to claim 1, wherein the protection film comprises a fluorinated oil.

4. The fine structure composite according to claim 1, wherein the protection film comprises a mixture of poly(vinyl alcohol) and water.

5. The fine structure composite according to claim 1, wherein the protection film comprises an amphipathic compound containing a hydrophilic group and a hydrophobic group.

6. The fine structure composite according to claim 5, wherein the hydrophobic group of the amphipathic compound comprises a C—F bond.

7. The fine structure composite according to claim 5, wherein the hydrophilic group of the amphipathic compound is an OH group or a COOH group.

8. The fine structure composite according to claim 5, wherein the amphipathic compound comprises a fluorinated alcohol or a fluorinated carboxylic acid.

9. A method for drying a fine structure, comprising the steps of:
forming the fine structure composite according to claim 1;
transporting the fine structure composite so as to place it in a high pressure chamber;
removing the protection film by extraction from the surface of the fine structure using a liquefied or a supercritical fluid which flows through the high pressure chamber; and
evaporating the liquefied or the supercritical fluid from the surface of the fine structure by reducing the pressure.

10. A fine structure obtained by the method according to claim 9.
